(19) United States
(12) Patent Application Publication
(10) Pub. No.: US 2010/0310911 A1
(43) Pub. Date: Dec. 9, 2010

(54) BATTERY PACK

(75) Inventors: Takeru Yamamoto, Fukushima (JP); Takehiko Tanaka, Fukushima (JP); Masayuki Tohda, Fukushima (JP); Tetsuya Makino, Fukushima (JP); Kengo Ichimiya, Fukushima (JP); Masafumi Umekawa, Fukushima (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/774,821

(22) Filed: May 6, 2010

(30) Foreign Application Priority Data
Jun. 3, 2009 (JP) P2009-134354

(51) Int. Cl. H01M 6/10

(52) U.S. Cl. 429/94

(57) ABSTRACT

A battery pack includes a plurality of batteries, each including a battery element formed by winding or stacking a positive electrode and a negative electrode with a separator therebetween, and a packaging material packaging the battery element; a connecting member that electrically connects the batteries to form a battery group; a holding unit that holds the batteries together; a protection circuit substrate connected to the battery group; and an outer packaging member that integrally covers the battery group and the protection circuit substrate, the outer packaging member being formed by filling a space in a molding die housing the battery group and the protection circuit substrate with a resin and curing the resin at a temperature of 100° C. or less.

### CROSS REFERENCES TO RELATED APPLICATIONS

The present application claims priority to Japanese Priority Patent Application JP 2009-134354 filed in the Japan Patent Office on Jun. 3, 2009, the entire content of which is hereby incorporated by reference.

### BACKGROUND

The present application generally relates to a battery pack, e.g., a battery pack including nonaqueous electrolyte secondary batteries. In particular, the present application relates to a battery pack that integrates a battery group and a protection circuit substrate therefor, the battery group including a plurality of batteries each including a battery element which is formed by winding or stacking a positive electrode and a negative electrode with a separator therebetween and which is packaged with a packaging material.

Recently, a large number of portable electronic appliances such as camcorders, cellular phones, portable computers, etc., have emerged and the size and weight of these appliances are increasingly reduced. As the electronic appliances become smaller and more light-weight, the battery packs used as portable power supplies for these electronic appliances are also desired to be smaller and lighter and achieve high energy. One example of the batteries used in such battery packs is high-capacity lithium ion secondary batteries.

A lithium ion secondary battery includes a battery element that includes a positive electrode and a negative electrode that can be doped or dedoped with lithium ions. This battery element is enclosed in a metal can or a metal laminate film and controlled by a circuit substrate electrically connected to the battery element. Some lithium ion secondary batteries of the related art are housed together with circuit substrates in a casing that has an upper part and a lower part so as to form a battery pack (refer to Japanese Patent Nos. 3556875, 3614767, and 3643792).

### SUMMARY

With regard to the lithium ion secondary batteries of the related art described above, when metal cans are used to enclose the battery elements, the thickness and weight tend to be large although high dimensional accuracy can be easily achieved. In contrast, when metal laminate films are used to enclose battery elements, a higher volume energy density can be achieved and thickness and weight can be reduced compared to when metal cans are used. However, since dimensions of battery elements vary significantly, it has been difficult to improve the dimensional accuracy and the mechanical strength thereof has been low.

Also, in recent years, battery packs that integrate a plurality of batteries are increasingly used. Examples thereof include battery packs for automobiles using nickel hydride batteries, which have already been put to practical use, and battery packs for notebook computers and power tools. However, since batteries in the battery packs undergo repeated expansion and contraction with charge/discharge operation, the total amount of deformation is not negligible although the amount of deformation of individual batteries is small. Thus, in the related art, the only viable option has been to use cylindrical batteries that do not deform significantly. In such cases, however, large spaces exist between batteries and thus the volume efficiency is low.

It is desirable to provide a battery pack that includes a plurality of batteies having high volume energy density and that has good dimensional accuracy and mechanical strength even when rectangular batteries with high volume efficiencies are used according to an embodiment.

An embodiment provides a battery pack including a plurality of batteries, each including a battery element formed by winding or stacking a positive electrode and a negative electrode with a separator therebetween, and a packaging material packaging the battery element; a connecting member that electrically connects the batteries to form a battery group; a holding unit that holds the batteries together; a protection circuit substrate connected to the battery group; and an outer packaging member that integrally covers the battery group and the protection circuit substrate, the outer packaging member being formed by filling a space in a molding die housing the battery group and the protection circuit substrate with a resin and curing the resin at a temperature of 100° C. or less.

The resin of the outer packaging material preferably contains one resin selected from a urethane resin, an acryl resin, and an epoxy resin. More preferably, the resin is a curable resin selected from a urethane resin, an acryl resin, and an epoxy resin and contains an endothermic agent composed of a compound that undergoes an endothermic reaction.

The inventors of the present application have found that such a battery pack is suitable for automobile usages since it suppresses battery deterioration, has good damping and impact resistance properties, and is obtainable at lower cost.

In other words, according to this battery pack, a battery element including a positive electrode, a negative electrode, and a separator is hermetically sealed with a packaging material such as a laminate film to form a battery. Then a battery group including a plurality of such batteries is housed in a molding die and integrated with a protection circuit substrate using a resin (outer packaging member). Thus, the battery pack is free of contact thermal resistance between minute heat insulating portions and components.

When a resin having good thermal conductivity and a filler are contained in the outer packaging member of the battery pack, deterioration of some batteries caused by a uneven thermal distribution can be significantly suppressed. When the capacities of some of the batteries are deteriorated, other batteries become overcharged, resulting in lithium precipitation and acceleration of deterioration of other batteries, thereby creating a vicious cycle. In contrast, the battery pack described above develops very little uneveness of battery deterioration even after 1000 cycle testing.

Disconnections of terminals, such as tabs, leads, etc., of the batteries may occur in parts of circuits due to aged deterioration and continuous vibrations and impacts. When disconnection occurs, the electrical current that is supposed to flow into batteries isolated by disconnection flows into the batteries that remain connected. Thus, in such batteries that remain connected, a current twice as large as the set current value may flow. As a result, in electrochemically driven batteries, unsafe operation conditions that cause lithium precipitation and side reactions due to overcharging progress continuously, possibly resulting in very serious battery deterioration and reliability degradation. In contrast, the terminals of the battery pack described above are extended from the batteries and fixed without allowance. Thus, the failure mode mentioned above can be avoided.

According to an embodiment, a battery pack that includes a plurality of batteries having higher volume energy density than batteries using metal cans can be provided. Even when rectangular batteries having high volume efficiencies are used, a battery pack with good dimensional accuracy and mechanical strength can be provided. Moreover, the size and weight of the battery packs can be reduced, and the safety and reliability can be further improved.

Additional features and advantages are described herein, and will be apparent from the following Detailed Description and the figures.

### BRIEF DESCRIPTION OF THE FIGURES

FIG. 1 is a perspective view illustrating the process of assembling a battery;

FIG. 2 is a perspective view showing a structure of a battery element;

FIG. 3A is a diagram showing a state before bending both sides of a battery and FIG. 3B is a diagram showing a state after bending both sides of the battery;

FIG. 4 is a cross-sectional view illustrating an embodiment of a battery pack;

FIG. 5 is a front view of a battery including a battery element packaged with a packaging material;

FIG. 6 is a diagram showing an example of a battery group in which batteries are electrically connected to each other through connecting members;

FIG. 7 is a diagram showing another example of a battery group;

FIG. 8 is a diagram showing yet another example of a battery group;

FIGS. 9A to 9E are plan views respectively showing examples of holding units;

FIGS. 10A to 10C are perspective views illustrating the process of producing a battery pack, from which illustration of holding units is omitted; and

FIGS. 11A to 11C are perspective views illustrating the process of producing battery packs using holding units.

### DETAILED DESCRIPTION

The present application will now be described in detail with reference to the drawings according to an embodiment. In this description, the symbol “%” used to describe concentrations, contents, filling ratios, etc., refers to percent by mass unless otherwise noted.

A battery pack includes a plurality of batteries, connecting members that electrically connect the batteries to each other to form a battery group, a holding unit that holds the batteries together, a protection circuit substrate connected to the battery group, and an outer packaging material that integrally covers the battery group, the protective circuit substrate, etc. Each of the batteries includes a battery element formed by winding or stacking a positive electrode and a negative electrode with separators therebetween, and a packaging material covering the battery element. The outer packaging material is formed by filling a space in a molding die housing the battery group and the protection circuit substrate with a resin and curing the resin at a temperature of 100° C. or less.

This battery pack has connecting members that electrically connect the batteries to each other and a holding unit that holds the batteries together, but does not need large-sized components such as bus bars, base plates, and springs. Thus, the volume energy density can be increased.

The battery element packaged with a packaging material has dimensional tolerance derived from the coated area density of the electrodes and the press density. The connecting member does not have to be a common, firmly built bus bar constituted by a plurality of components. A simple member that holds between the terminals (tab leads) of the battery can be used as the connecting member instead. This is because eventually a resin fills the space beside the terminals and exhibits strength and an insulating property once cured.

The holding unit may be a simple member designed on the basis of the maximum dimensions of the battery because the holding unit will eventually be integrated with an outer packaging member (resin) and the strength and the pressure retention can be ensured. The holding unit may be a member separate from a molding die, for example, or may be a pin, a hook, a dent, a recess, or the like for positioning integrated with the molding die. The holding unit not only holds the batteries together but also fixes the battery group onto the molding die. The molding die may be, for example, a resin molding die constituted by a plurality of segments or a simple casing.

According to a more preferred embodiment of the battery pack, a resin in the outer packaging member may contain one of a urethane resin, an acryl resin, and an epoxy resin. The resin in the outer packaging member may be a curable resin selected from a urethane resin, an acryl resin, and an epoxy resin and may contain an endothermic agent containing a compound that undergoes endothermic reactions.

The resin of the outer packaging member of the battery pack preferably has an elongation of 5% or more and 40% or less according to Japanese Industrial Standard (JIS) K-7113. When the elongation is less than 5%, cracking readily occurs due to vibrations or impacts; hence, in a long-term operation in which expansion and contraction repeatedly occur in charge/discharge cycles, the decrease in strength caused by similar local cracking and changes in dimensions become problematic. When the elongation exceeds 40%, expansion and contraction of batteries may not be sufficiently suppressed and the interface between the positive and negative electrodes may not be maintained.

The resin of the outer packaging member of the battery pack preferably has a deflection temperature of 60° C. or more and 150° C. or less under a load of 0.45 MPa according to JIS K-7191, or a glass transition temperature (Tg) of 55° C. or more and 150° C. or less.

The glass transition temperature (Tg) is preferably measured on the basis of reaction delays, changes in elasticity (tan δ) under deformation such as bending, stretching, or shearing, or the like measured with a dynamic mechanical spectrometer (DMS) so as to detect with high sensitivity the local relaxations and the like of a polymeric material not detectable by general thermal analysis. In these measurements, EXSTAR DMS6100, a DMS produced by Seiko Instruments Inc., was used and bending deformation was imparted such that the bending elasticity changed from 10 to 120 MPa while the ambient environment temperature was changed from 20° C. to 200° C. so as to estimate the glass transition temperature (Tg) from the point of change in elasticity. Alternatively, the glass transition temperature may be determined by using the point of inflection determined by differential scanning calorimetry (DSC) or the point of change in coefficient of linear expansion determined by measuring the elongation per degree Celsius of a solid having a unit length under a particular pressure.

When the deflection temperature under load is lower than 60° C. or the glass transition temperature is lower than 55° C. and when the ambient temperature increases to near 60° C., the toughness and viscosity rapidly decrease and the outer packaging member becomes highly susceptible to deformation. Thus, deformation may occur due to vibrations or impacts that occur under typical operation conditions. Deformation also occurs due to expansion and contraction accompanying charge/discharge operations. Conversely, when the deflection temperature under load or the glass transition temperature is over 150° C., it takes a longer time and a higher temperature for curing, resulting in a decrease in productivity. In the case where the hardness of the outer package remains unchanged up to 150° C., ensuring sufficient strength during normal operation may degrade safety since it may suppress the quick splitting characteristic of polymer batteries at a temperature under abnormal conditions.

The outer packaging member of the battery pack having the above-described structure contains a shape-retaining polymer that contains an insulating curable polyurethane resin containing a polyol and a polyisocyanate.

In general, when a resin-containing material is used in the outer packaging member, the outer packaging member is usually formed by integrally covering the battery group and the protection circuit substrate by using, for example, a die hot melting technique. In this case, a thermoplastic resin that liquefies under heating and re-solidifies under cooling or a curable resin that is curable with, for example, heat is used.

However, since a thermoplastic resin develops fluidity after being heated to a temperature 50° C. to 150° C. higher than the melting point or the glass transition point (glass transition temperature) of the resin, the thermoplastic resin is usually heated to a high temperature of about 180° C. to 450° C. Curing of a thermoplastic resin starts the moment the resin is injected into a die. Thus, in order to make a thin molded product, the resin is supplied from a very narrow opening to cover a large area, and this involves a process of injecting resin that has a tendency to solidify in few seconds near the injection port. Even when the resin is heated to a high temperature to decrease the viscosity of the resin, even when the pressure of injection is increased, or even when the number of injection ports is increased, battery packs having a large area and a thickness of 250 μm or less are difficult to obtain. In other words, only battery packs having volume energy densities inferior to those using metal cans can be fabricated when a resin is used in the outer packaging member. On the other hand, when a thermosetting resin of the related art is used, the curing temperature is as high as about 150° C. and the productivity is low because of a long curing time.

Polyethylene-based separators commonly used in nonaqueous electrolyte secondary batteries usually shut down at a temperature of 120° C. to 140° C., turn into films that do not allow ions to pass therethrough, and may no longer function as the separators. The electrolytes (e.g., polyvinylidene fluoride used as nonaqueous electrolytes) contained in the batteries may undergo changes in physical properties, possibly resulting in deformation of batteries.

A battery pack in which a battery group and a protection circuit substrate are integrated has a positive temperature coefficient (PCT) element built into the protection circuit so that the PCT element functions as a controller in the event of abnormal current flow. The term “positive temperature coefficient” means that the electrical resistance of the PTC element increases with the temperature and thus has a positive coefficient. However, heating at such a high temperature may change the coefficient value and may damage elements such as temperature thermal cutoffs, and the protection circuit substrate may stop functioning as a result.

According to the battery pack of one embodiment, an insulating curable polyurethane resin containing a polyol and a polyisocyanate is used as a shape-retaining polymer included in the outer packaging member. Thus, the battery group and the protection circuit can be integrally covered at relatively low temperatures (e.g., 120° C. or less), and a battery pack that achieves high dimensional accuracy and high mechanical strength as well as size and weight reduction can be provided without damaging the battery group or the protection circuit substrate.

Since the outer packaging member containing the insulating curable polyurethane resin is used, the dimensional accuracy is improved. Thus, a battery pack made with the outer packaging member is thinner than one using metal plates and exhibits higher yield and improved energy density. Moreover, since the productivity and the workability are improved by the use of this outer packaging member, battery packs of various sizes, shapes, strengths, etc., suitable for various usages can be produced and the flexibility of design can be increased.

Outer Packaging Member: Shape-Retaining Polymer

A shape-retaining polymer included in the outer packaging material of a battery pack of one embodiment contains an insulating curable polyurethane resin that contains a polyol and a polyisocyanate. In this specification, the “insulating curable polyurethane resin” refers to a material that yields a cured product having a volume resistivity value (Ω·cm) of 10¹⁰Ω·cm or more measured at 25±5° C. and 65±5% RH, and more preferably, a material that yields a cured product having a volume resistivity value of 10¹¹Ω·cm or more. The insulating curable polyurethane resin preferably yields a cured product having a dielectric constant of 6 or less (1 MHz) and a breakdown voltage of 15 kV/mm or more. The volume resistivity value is measured according to JIS C2105 by measuring the value 60 seconds after starting application of a 500 V measurement voltage to a sample (thickness: 3 mm) at 25±5° C. and 65±5% RH.

The polyol included in the insulating curable polyurethane resin preferably has an oxygen content of 30% or less and more preferably 20% or less. When the oxygen content of the polyol is 30% or less, the physical properties of the cured product obtained therefrom do not readily change. The cured product exhibits high moisture and heat resistance and an insulating property and is thus suitable for use as the outer packaging member of the battery pack.

The polyol included in the insulating curable polyurethane resin preferably has an iodine number of 200 or less and more preferably 150 or less. When the iodine value of the polyol used in the shape-retaining polymer included in the outer packaging member is 200 or less, the resulting cured product exhibits high thermal resistance and becomes neither hard nor brittle even in a high temperature environment. Thus, the cured product is suitable for use as the outer packaging material that integrally covers the battery group and the protection circuit substrate. The iodine value is measured according to JIS K3331-1995.

The polyol included in the insulating curable polyurethane resin is preferably a polyester polyol, a polyether polyol, or a polyol having a main chain composed of carbon-carbon bonds, or a mixture of these.

The polyester polyol is a reaction product of a fatty acid and a polyol. The fatty acid may be at least one hydroxy-containing long-chain fatty acid selected from the group consisting of ricinoleic acid, oxycapronic acid, oxycapric acid, oxyundecanoic acid, oxylinoleic acid, oxystearic acid, and oxyhexadecenoic acid. The polyol reacting with the fatty acid may be at least one selected from the group consisting of glycols such as ethylene glycol, propylene glycol, butylene glycol, hexamethylene glycol, and diethylene glycol, trifunctional polyols such as glycerin, trimethylolpropane, and triethanolamine, tetrafunctional polyols such as diglycerin and pentaerythritol, hexafunctional polyols such as sorbitol, and octafunctional polyols such as maltose and sucrose. Other examples thereof include addition polymers of aliphatic, alicyclic, or aromatic amines and alkylene oxides corresponding to these polyols and addition polymers of polyamide-polyamine and such alkylene oxides.

In particular, ricinoleic acid glyceride, a polyester polyol of ricinoleic acid and 1,1,1-trimethylolpropane, or the like is preferably used.

The polyether polyol is composed of an addition polymer of an alcohol and an alkylene oxide. The alcohol may be at least one selected from the group consisting of ethylene glycol, diethylene glycol, propylene glycol, dipropylene glycol, dihydric alcohols such as 1,3-butanediol, 1,4-butanediol, 4,4′-dihydroxyphenylpropane, and 4,4′-dihydroxyphenylmethane, and trihydric or higher alcohols such as glycerin, 1,1,1-trimethylolpropane, 1,2,5-hexanetriol, and pentaerythritol. The alkylene oxide may be at least one selected from the group consisting of ethylene oxide, propylene oxide, butylene oxide, and α-olefin oxide.

The polyol having a main chain composed of carbon-carbon bonds may be at least one selected from the group consisting of acryl polyol, polybutadiene polyol, polyisoprene polyol, hydrogenated polybutadiene polyol, polycarbonate polyol, a polyol formed by grafting acrylonitrile (AN) or styrene monomer (SM) on a polyol containing C—C bonds, and polytetramethylene glycol (PTMG).

The polyol included in the insulating curable polyurethane resin preferably contains a powder. When the polyol contains a powder, the insulating curable polyurethane resin containing the polyisocyanate and the polyol containing the powder exhibits good thixotropy in integrally covering the battery group and the protection circuit substrate and thereby improves the workability. Moreover, since the polyol contains a powder, the outer packaging member made of an insulating curable polyurethane resin containing the polyisocyanate and the polyol containing the powder exhibits improved surface hardness, heat resistance, and heat dissipating property, etc.

Examples of the powder include inorganic particles such as calcium carbonate, aluminum hydroxide, aluminum oxide, silicon oxide, titanium oxide, silicon carbide, silicon nitride, calcium silicate, magnesium silicate, and carbon, and organic polymer particles such as polymethyl acrylate, polyethyl acrylate, polymethyl methacrylate, polyethyl methacrylate, polyvinyl alcohol, carboxymethyl cellulose, polyurethane, and polyphenol. These may be used alone or in combination. Surfaces of the particles constituting these powders may be surface-treated. The polyurethane or polyphenol used as powders may be used as foamed powders. Moreover, the powders may be porous.

The polyisocyanate included in the insulating curable polyurethane resin is preferably an aromatic polyisocyanate, an aliphatic polyisocyanate, or an alicyclic polyisocyanate, or a mixture of these.

Examples of the aromatic polyisocyanate include diphenylmethane diisocyanate (MDI), polymethylene polyphenylene polyisocyanate (crude MDI), tolylene diisocyanate (TDI), polytolylene polyisocyanate (crude TDI), xylene diisocyanate (XDI), and naphthalene diisocyanate (NDI). Examples of the aliphatic polyisocyanate include hexane methylene diisocyanate (HDI). Examples of the alicyclic polyisocyanate include isophorone diisocyanate (IPDI).

Other examples of the polyisocyanate include carbodiimide-modified polyisocyanate produced by modifying the aforementioned polyisocyanate with carbodiimide, isocyanurate-modified polyisocyanate produced by modifying the aforementioned polyisocyanate with isocyanurate, and isocyanate-terminated urethane polymers produced by reaction between a polyol and the polyisocyanate in excess. The polyisocyanates may be used alone or in combination.

In particular, diphenylmethane diisocyanate, polymethylene polyphenylene polyisocyanate, or carbodiimide-modified polyisocyanate is preferably used.

A catalyst is added to the insulating curable polyurethane resin to allow reactions between the polyol and the polyisocyanate and promote dimerization and trimerization of isocyanates. Common catalysts that catalyze the above-described reactions can be used as the catalyst. Examples of the catalysts include amine-based catalysts, metal-based isocyanuration catalysts, and organotin compounds.

Examples of the amine-based catalyst include tertiary amines such as triethylene diamine, 2-methyltriethylenediamine, tetramethylhexanediamine, pentamethyldiethylenetriamine, pentamethyldipropylenetriamine, pentamethylhexanediamine, dimethylaminoethylether, trimethylaminopropylethanolamine, tridimethylaminopropylhexahydrotriazine, and tertiary ammonium salts.

Examples of the metal-based isocyanuration catalyst include fatty acid metal salts such as dibutyltin dilaurate, lead octylate, potassium ricinoleate, sodium ricinoleate, potassium stearate, sodium stearate, potassium oleate, sodium oleate, potassium acetate, sodium acetate, potassium naphthenate, sodium naphthenate, potassium octylate, sodium octylate, and mixtures thereof.

A metal-based isocyanuration catalyst is preferably used since isocyanurate rings can be introduced into the molecules of the insulating curable polyurethane resin and the flame retardancy and heat resistance of the cured product improve by the presence of the isocyanurate rings. The metal-based isocyanuration catalyst is preferably used in the range of 0.5 parts by weight or more and 20 parts by weight or less relative to 100 parts by weight of the polyol. When the amount of the metal-based isocyanuration catalyst is less than 0.5 parts by weight, sufficient isocyanuration does not occur. When the amount of the metal-based isocyanuration catalyst is more than 20 parts by weight relative to 100 parts by weight of the polyol, the effect that corresponds to the amount added is rarely achieved.

Examples of the organotin compound include tri-n-butyltin acetate, n-butyltin trichloride, dimethyltin dichloride, dibutyltin dichloride, and trimethyltin hydroxide. These catalysts may be used as are or may be dissolved in a solvent such as ethyl acetate so that the concentration thereof is in the range of 0.1 to 20%, and then added so that the catalyst content in terms of solid is 0.01 to 5 parts by weight relative to 100 parts by weight of isocyanate. Irrespective of whether the catalyst is added as is or as dissolved in a solvent, the catalyst content in terms of solid is preferably 0.01 to 5 parts by weight and more preferably 0.05 to 1 part by weight relative to 100 parts by weight of isocyanate. If the catalyst content is excessively small, i.e., less than 0.01 parts by weight, polyurethane resin molded article forms slowly and molding becomes difficult since curing does not produce a resinous matter. In contrast, when the catalyst content exceeds 5 parts by weight, a resin is formed excessively fast and is thus difficult to mold as a shape-retaining polymer included in the outer packaging member of the battery pack.

The shape-retaining polymer used as the outer packaging member of the battery pack may contain additives such as a filler, a flame retarder, a defoaming agent, an antibacterial agent, a stabilizer, a plasticizer, a thickner, an antifungal agent, another resin, etc., in addition to the insulating curable polyurethane resin as long as the curability is not degraded. For example, triethyl phosphate, tris(2,3-dibromopropyl) phosphate, or the like may be used as the flame retarder among the additives described above. Examples of other additives include fillers such as antimony trioxide and zeolite, and coloring materials such as dyes and pigments.

Outer Packaging Member: Filler

The outer packaging member included in the battery pack preferably contains, in addition to the shape-retaining polymer described above, a filler that contains a metal oxide, a metal nitride, or the like. Accordingly, the shape-retaining polymer containing the insulating curable polyurethane resin preferably has compatibility and reactivity with the filler. The shape-retaining polymer more preferably has good adhesiveness with a metal laminate film and good dimensional stability and moldability.

A ceramic filler, a metal oxide filler, or a metal nitride filler may be used as the filler. Examples of the metal oxide filler or the metal nitride filler include oxides or nitrides of silicon (Si), aluminum (Al), titanium (Ti), zirconium (Zr), zinc, (Zn), and magnesium (Mg) or any mixtures of the oxides or the nitrides. These fillers composed of metal oxides or nitrides improve hardness and thermal conductivity of the outer packaging member. A layer containing a metal oxide filler or a metal nitride filler may be disposed to be in contact with a layer containing the shape-retaining polymer. Alternatively, the metal oxide filler or the metal nitride filler may be mixed into the layer containing the shape-retaining polymer. In such a case, the metal oxide filler or the metal nitride filler is preferably evenly scattered over the entire shape-retaining polymer layer.

The ratio at which the filler is mixed may be changed depending on the type of the shape-retaining polymer but is preferably 3 to 60% relative to the total mass of the shape-retaining polymer. If the amount of filler is less than 3%, an outer packaging member having a sufficient hardness may not be obtained. If the amount of filler is more than 60%, problems associated with moldability during production and brittleness of the ceramic may arise.

When the average particle diameter of the filler is decreased, the hardness increases but productivity may be degraded since the decrease in average particle diameter affects the filling property during molding. In contrast, when the average particle diameter of the filler is increased, the desired strength may not be obtained and the dimensional accuracy of the battery pack may not be satisfactory. Thus, the average particle diameter of the filler is preferably 0.5 to 40 μm and more preferably 2 to 20 μm.

The particles of the filler may take various shapes, such as spherical, scale-like, plate-like, and needle-like shapes. Although the shape of filler particles is not particularly limited, spherical filler particles are preferable since spherical filler particles with uniform average particle diameters can be produced easily and are available at low cost. Needle-shaped filler particles having high aspect ratios are also preferable since the strength can be easily increased. The scale-shaped filler particles are also preferred since the filling property can be increased when the ratio of the filler mixed is high. Note that it is possible to use filler particles having different average particle diameters and shapes as a mixture according to the usage and the material.

The outer packaging material may contain various other additives in addition to the shape-retaining polymer and the filler described above. For example, a curing agent, a UV absorber, a photostabilizer, and any mixtures of these may be used in addition to the shape-retaining polymer.

Characteristics of Outer Packaging Member

The battery pack of this embodiment uses the outer packaging member containing the insulating curable polyurethane resin as the shape-retaining polymer. This increases the dimensional accuracy, impact resistance, and mechanical strength and reduces the size (thickness) and the weight of the battery pack. This outer packaging member preferably has the following physical property values.

The glass transition point (Tg) of the outer packaging member, which contains the insulating curable polyurethane resin that serves as the insulating shape-retaining polymer, measured by differential scanning calorimetry (DSC) is preferably 45 to 130° C., more preferably 65 to 120° C., and most preferably 75 to 110° C. The outer packaging member preferably has good impact resistance and mechanical strength during normal operation but is preferably easily breakable upon occurrence of abnormal conditions so that the gas generated from the battery can be easily discharged to the outside. A curable polyurethane resin is preferably used as such a shape-retaining polymer included in the outer packaging member. In order to satisfy these requirements, the outer packaging member containing the shape-retaining polymer preferably has a glass transition point equal to or higher than the temperature at which the battery pack is normally used but equal to or lower than the temperature at which abnormal conditions occur. When the glass transition point is less than 45° C., the glass transition point of the outer packaging member containing the shape-retaining polymer may become lower than the temperature of normal use. This is not preferred since it becomes difficult to suppress the thermal motion of molecules constituting the shape-retaining polymer, to retain curability, and to allow good mechanical strength to develop. In contrast, when the glass transition point exceeds 130° C., the glass transition point of the outer packaging member containing the shape-retaining polymer may exceed the temperature at which abnormal conditions occur. Thus, the thermal motion of molecules constituting the shape-retaining polymer is suppressed under abnormal conditions, the outer packaging member becomes not readily breakable, and it becomes difficult for gas generated under abnormal conditions to be rapidly discharged to the outside.

The flexural strength of the outer packaging member containing the shape-retaining polymer determined by Plastics—Determination of flexural properties according to JIS K7171 is preferably 10 to 120 MPa, more preferably 20 to 110 MPa, and most preferably 70 to 100 MPa.

The flexural modulus of the outer packaging member containing the shape-retaining polymer determined by Plastics—Determination of flexural properties according to JIS K7171 is preferably 30 to 3000 MPa, more preferably 900 to 2550 MPa, and most preferably 1000 to 2500 MPa.

The outer packaging member containing the shape-retaining polymer has a surface hardness of preferably D30 to D99, more preferably D60 to D90, and most preferably D60 to D85 determined by testing methods for durometer hardness of plastics according to JIS K7215. When the durometer D hardness of the outer packaging member is D30 to D99, an outer packaging member having high impact resistance and mechanical strength can be obtained. The durometer D hardness of the outer packaging member measured at a temperature under abnormal conditions, e.g., 60° C. or higher, is preferably lower than the durometer D hardness of the outer packaging member measured in a normal environment (temperature of 23° C.±2° C. and 50±5% RH) prescribed in JIS K7215. When the hardness of the outer packaging member at a temperature under abnormal conditions is smaller than the hardness under normal conditions, the gas generated under abnormal conditions readily splits the outer packaging member and the gas can be rapidly discharged to the outside in the event of splitting of the outer packaging member.

The outer packaging member is thin. For example, the thickness of the pack portion covering the largest area of a rectangular battery for portable appliance usage is 1000 μm or less. When the thickness exceeds 1000 a battery pack made using this outer packaging member may not fully exhibit advantages in terms of volume energy density. More preferably, the thickness is 300 μm or less. The thickness is preferably as small as possible as long as the impact resistance and mechanical strength desirable for the battery pack can be satisfied.

The combined use of the shape-retaining polymer and the filler yields higher strength and higher impact resistance than the use of aluminum metals or the combined use of a thermoplastic resin and a metal in the related art. Thus, the same strength can be achieved with smaller thickness, thereby increasing the volume energy density. When the outer packaging member is thick, a battery pack having a higher strength and higher reliability than the related art can be obtained. Since the size and shape of the battery can be relatively freely selected, the battery pack can be applied to large-sized batteries such as backup power supplies of bicycles and can be freely designed to fit in a desired place while achieving a desired strength.

The resin of the outer packaging member of the battery pack is preferably composed of one of the urethane resin, the acryl resin, and the epoxy resin and preferably contains an endothermic agent containing a compound that undergoes an endothermic reaction. More preferably, the endothermic agent contains a compound that undergoes an endothermic reaction in the range of 90 to 150° C.

Since a curable resin is used in this embodiment and the endothermic compound can be added to the curable resin in a liquid state before curing, the effect of suppressing temperature under abnormal conditions can be achieved easily, in particular, without increasing the number of production processes. Since the endothermic compound can be added as a substitute for an inorganic filler, the surface hardness of the resin can be improved and a new effect of suppressing the swelling of the battery pack has been confirmed by a high-temperature storage test at 60° C., i.e., below the endothermic temperature. Since the appearance is not affected, characters and the like may be laser-printed on the resin surface to eliminate labels, thereby further improving the volume energy density.

Examples of the endothermic agent include common endothermic agents such as hydroxides, hydrates, clathrate hydrates such as tetrahydrofuran (C₄H₈O.17H₂O) and cyclodextrin, hydrate salts such as sodium sulfate decahydrate, sodium tetraborate decahydrate (Na₂B₄O₇.10H₂O), and ammonium tetraborate tetrahydrate ((NH₄)₂B₄O₇.4H₂O), and carbonate compounds.

The metal hydroxide preferably contains copper, zinc, aluminum, cobalt, or nickel and may be any one of copper hydroxide, zinc hydroxide, aluminum hydroxide, cobalt hydroxide, and nickel hydroxide. In particular, copper hydroxide is preferred since it causes dehydration and a reaction for generating a metal oxide at a temperature of 100° C. or higher and yields a large endothermic effect.

The metal hydrate is preferably selected from metal hydrates of copper, zinc, aluminum, cobalt, calcium, zirconium, nickel, and magnesium. Preferred examples thereof include CuSO₄.5H₂O, ZnSO₄.H₂O, ZnSO₄.7H₂O, AlCl₃.6H₂O, aluminum silicate n-hydrate, (Al(NO₃)3.9H₂O), hydrates of CoCl₂ such as 1.5-hydrate, 2-hydrate, 4-hydrate, and 6-hydrate of CoCl₂, 2-hydrate, 4-hydrate, and 6-hydrate of CaCl₂, calcium silicate hydrate, calcium sulfate hydrate, zirconium oxychloride octahydrate, zirconium oxynitrate dihydrate, zirconium dioxide hydrate, nickel sulfate hexahydrate, nickel nitrate hexahydrate, nickel chloride hexahydrate, magnesium sulfate hydrate, magnesium fluoride hydrate, magnesium chloride hexahydrate, bassanite (CaSO₄.0.5H₂O), and gypsum (CaSO₄.2H₂O). Calcium sulfate (CaSO₄.2H₂O) that starts endothermic reactions from at about 128° C. and calcium sulfite (CaSO₃.2H₂O) that starts endothermic reactions at about 100° C. are more preferable.

Any common carbonate salt can be used as the carbonate compound. In particular, basic zinc carbonate is preferred since its thermal decomposition temperature is about 120° C. These endothermic compounds may be used in combination with any compound that has been used as a filler to increase the mechanical strength and the flame retardancy.

The temperature at which endothermic reactions start (a.k.a., onset temperature of endothermic reactions) was estimated by differential scanning calorimetry (DSC). DSC6100 produced by SII was used as the measuring instrument and a 20 mg of a sample was weighed, sealed in an aluminum pan, and heated at 2° C./min from normal temperature to 600° C., i.e., the melting point of aluminum. The temperature at which the endothermic peak starts was confirmed and this temperature was assumed to be onset temperature of endothermic reactions.

The resin used in the outer packaging member of the battery pack of this embodiment is preferably a thermosetting resin. Alternatively, a thermoplastic resin, a curable resin that has already been cured, a metal plate, or a metal component may be used in part of the outer packaging member to improve the productivity, the positioning accuracy, and the production takt time.

The thermoplastic resin may be any but is preferably polyethylene, polypropylene, polyamide, or polycarbonate. From the viewpoints of adhesiveness to the thermosetting resin, flame retardancy, and mechanical strength, polyamide or polycarbonate is more preferably used. The curable resin may be any but is preferably an acryl resin, an epoxy resin, or a urethane resin. More preferably, the same resin as the resin injected into a die is used from the viewpoints of raw material cost, shared use of production facilities, adhesive strength, etc.

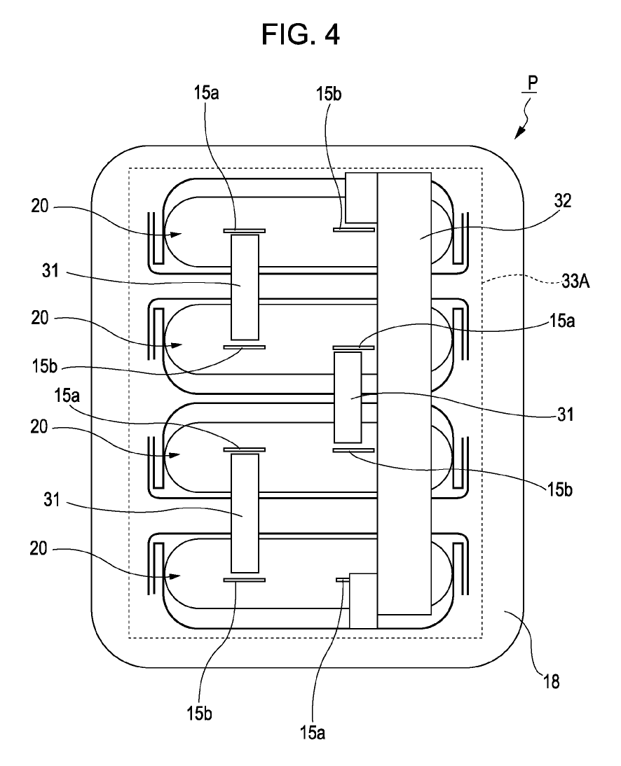

Next, an embodiment of a battery pack is described with reference to the drawings. A battery pack P shown in FIG. 4 includes a plurality of batteries 20, connecting members 31 that electrically connect the batteries 20 to form a battery group G, a holder 33A that holds the batteries 20 together, a protection circuit substrate 32, and an outer packaging member 18 that integrally covers the battery group G, the protection circuit substrate 32, the holder 33A, and other associated components. The outer packaging member 18 is formed by filling the space inside a casing (molding die) C housing the battery group G and the protection circuit substrate 32 with a resin and curing the resin at a temperature of 100° C. or less. The outer packaging member 18 shown in the drawing integrally covers the battery group G, the protection circuit substrate 32, and other associated components while having terminals of the batteries 20 extended to the outside.

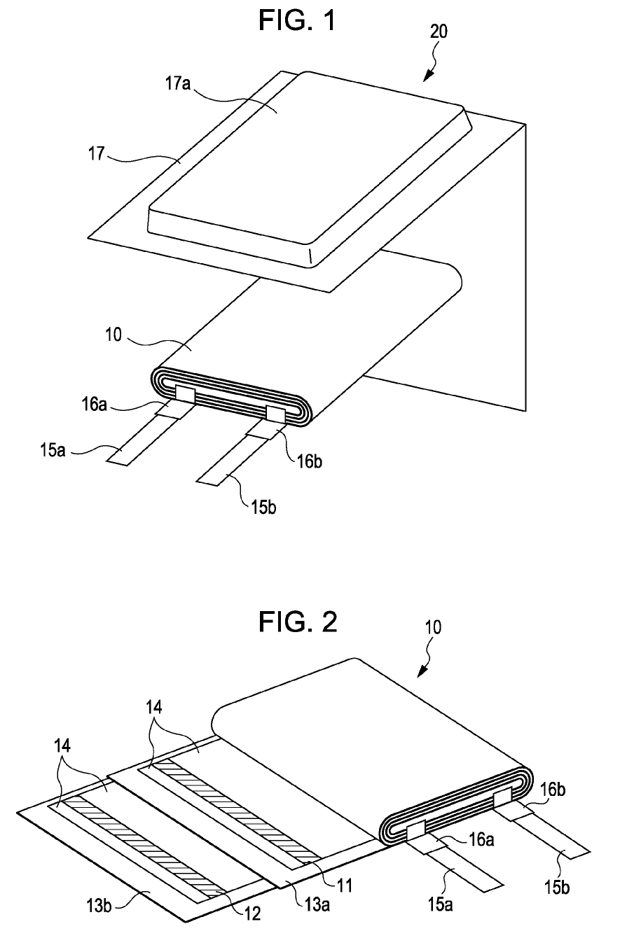

The batteries 20 are nonaqueous electrolyte secondary batteries and, as shown in FIG. 1, are each prepared by packaging a battery element 10 with a metal laminate film 17, which is one example of a packaging material. The battery element 10 is placed in a recess 17a (space 17a) formed in the laminate film 17 and the periphery of the battery element 10 is sealed. In this embodiment, the space 17a is a rectangular space having a shape corresponding to the rectangular shape of the battery element 10.

The packaging material for packaging the battery element 10 may be any common metal laminate film but is preferably an aluminum laminate film. The aluminum laminate film is preferably one suited for drawing and forming the recess 17a for housing the battery element 10.

The packaging material for packaging the battery element 10 is preferably a film including at least one layer, and preferably contains one of polyolefin and polyvinylidene. For example, a multilayer laminate film including an aluminum layer and an adhesive layer and a surface protection layer disposed on both sides of the aluminum layer can be used as the aluminum laminate film. An aluminum laminate film in which a propylene (PP) layer serving as an adhesive layer, an aluminum layer serving as a metal layer, and a nylon or polyethylene terephthalate (PET) layer serving as the surface protection layer are arranged in that order from the inside of the battery element 10, i.e., from the surface side of the battery element 10 is preferably used as the aluminum laminate film.

The structure of the battery element 10 will now be described. FIG. 2 is a perspective view showing the structure of the battery element 10 packaged and housed in the laminate film 17 serving as the packaging material. In the drawing, a strip-shaped positive electrode 11, a separator 13a, a strip-shaped negative electrode 12 disposed to oppose the positive electrode 11, and a separator 13b are sequentially stacked and wound in the longitudinal direction to form the battery element 10. Both sides of the positive electrode 11 and the negative electrode 12 are coated with a gel electrolyte 14.

A positive electrode terminal 15a that connects to the positive electrode 11 and a negative electrode terminal 15b that connects to the negative electrode 12 (hereinafter, these terminals may be referred to as “electrode terminals 15” without designating specific terminals to which they connect) are extended from the battery element 10. The positive electrode terminal 15a and the negative electrode terminal 15b are respectively coated with a sealant 16a and a sealant 16b (hereinafter, the sealants may be generally referred to as “sealants 16”) which are resin pieces composed of polypropylene modified with maleic anhydride (PPa) or the like so as to improve the adhesiveness to the laminate film 17 provided later as a package.

The constitutional elements of the battery (before being packaged with the outer packaging member) will now be described in detail.

Positive Electrode

The positive electrode includes a positive electrode collector and positive electrode active material layers disposed on both sides of the positive electrode collector. The positive electrode active material layers contain a positive electrode active material. The positive electrode collector includes a metal foil such as an aluminum (Al) foil. The positive electrode active material layers contain, for example, a positive electrode active material, a conductant agent, and a binder. The positive electrode active material, the conductant agent, and the binder may be mixed at any ratio as long as they can be homogeneously dispersed in a solvent.

A metal oxide, a metal sulfide, or a particular polymer may be used as the positive electrode active material according to the type of the battery desired. For example, in order to construct a lithium ion battery, a complex oxide of a transition metal and lithium, represented by formula (I), may be used:

LiXMO₂ (1)

(where M represents at least one transition metal and X usually represents 0.05 to 1.10 although X varies depending on the charge/discharge state of the battery.) Cobalt (Co), nickel (Ni), manganese (Mn), etc., may be used as the transition metal (M) of the lithium complex oxide.

Specific examples of the lithium complex oxide include LiCoO₂, LiNiO₂, LiMn₂O₄, and LiNi_{y}CO_{1-y}O₂ (0<y<1). A solid solution having some atoms of the transition metal element substituted with atoms of a different element can also be used. Examples thereof include LiNi_{0.5}CO_{0.5}O₂ and LiNi_{0.8}CO_{0.2}O₂. These lithium complex oxides can generate high voltage and exhibit high energy density. A metal sulfide or oxide that does not contain lithium, such as TiS₂, MoS₂, NbSe₂, and V₂O₅ may be used as the positive electrode active material. These positive electrode active materials may be used alone or in combination.

A carbon material such as carbon black and graphite may be used as the conductant agent, for example. Polyvinylidene fluoride, polytetrafluoroethylene, polyvinylidene fluoride, etc., can be used as the binder. N-methylpyrrolidone and the like can be used as the solvent.

The positive electrode active material, the binder, and the conductant agent are homogeneously mixed to prepare a positive electrode mix, and this positive electrode mix is dispersed in a solvent to prepare a slurry. The slurry is evenly applied on the positive electrode collector by a doctor blade technique or the like, dried under a high temperature to evaporate solvent, and pressed to form positive electrode active material layers.

The positive electrode 11 includes the positive electrode terminal 15a connected to one end of the positive electrode collector by spot welding or ultrasonic welding. The positive electrode terminal 15a is preferably a metal foil or a mesh but does not have to be composed of a metal as long as the terminal is electrochemically and chemically stable and conducts electricity. Examples of the material for the positive electrode terminal 15a include aluminum.

Negative Electrode

The negative electrode includes a negative electrode collector and negative electrode active material layers disposed on both sides of the negative electrode collector. The negative electrode active material layers contain a negative electrode active material. The negative electrode collector includes a metal foil, e.g., a copper (Cu) foil, a nickel foil, or a stainless steel foil.

The negative electrode active material layer contains, for example, a negative electrode active material, a conductant agent if desired, and a binder. The negative electrode active material, the conductant agent, the binder, and the solvent may be mixed at any ratio as with the positive electrode active material.

A carbon material or metal-carbon complex material that can dope and dedope lithium metal, lithium alloys, or lithium can be used as the negative electrode active material. Specific examples of the carbon material that can dope and dedope lithium include graphite, non-graphitizable carbon, and graphitizable carbon. More specifically, carbon materials such as pyrolytic carbons, cokes (pitch coke, needle coke, and petroleum coke), graphites, glassy carbons, organic polymer compound sinters (produced by baking and carbonizing a suitable resin such as a phenol resin or furan resin at an appropriate temperature), carbon fibers, and activated carbon can be used. A polymer such as polyacetylene, polypyrrole, etc., or an oxide such as SnO₂ can be used as the material that can dope and dedope lithium.

Various types of metals can be used as a material that can alloy with lithium. For example, tin (Sn), cobalt (Co), indium (In), aluminum (Al), silicon (Si), and alloys of these are frequently used. When metallic lithium is used, it is not always necessary to use a metallic lithium powder and form the metallic lithium powder into a coating film using a binder. Instead, rolled lithium metal foils may be used and press-bonded onto the collector.

Examples of the binder include polyvinylidene fluoride and styrene butadiene rubber. For example, N-methylpyrrolidone or methyl ethyl ketone can be used as the solvent.

The negative electrode active material, the binder, and the conductant agent are homogeneously mixed to prepare a negative electrode mix, and this negative electrode mix is dispersed in a solvent to prepare a slurry. The slurry is evenly applied on the negative electrode collector by a technique similar to that for forming the positive electrode, dried under a high temperature to evaporate the solvent, and pressed to form negative electrode active material layers.

As with the positive electrode 11, the negative electrode 12 also includes a negative electrode terminal 15b connected to one end of the collector by spot welding or ultrasonic welding. The negative electrode terminal 15b does not have to be composed of a metal as long as it is electrochemically and chemically stable and conducts electricity. Examples of the material for the negative electrode terminal 15b include copper and nickel.

When the battery element 10 has a rectangular shape, the positive electrode terminal 15a and the negative electrode terminal 15b are preferably extended in the same direction from one side (usually one of the short sides) of the battery element 10 as shown in FIGS. 1 to 5. However, the direction in which the terminals are extended may be any as long as shorting or the like does not occur and the battery performance is not degraded. The positions to which the positive electrode terminal 15a and the negative electrode terminal 15b are connected may be any and the technique used for establishing the connections may be any as long as electrical contacts are achieved.

Electrolyte

An electrolyte salt and a nonaqueous solvent commonly used for lithium ion batteries can be used as the electrolyte.

Examples of the nonaqueous solvent include ethylene carbonate, propylene carbonate, γ-butyrolactone, dimethyl carbonate, diethyl carbonate, ethyl methyl carbonate, dipropyl carbonate, ethyl propyl carbonate, and solvents prepared by substituting hydrogen of the carbonic acid esters by a halogen. These solvents may be used alone or as a mixture including a plurality of types of solvents at a particular composition ratio.

A material commonly used in battery electrolytes can be used as the lithium salt, which is one example of the electrolyte salt. Specific examples thereof include LiCl, LiBr, LiI, LiClO₃, LiClO₄, LiBF₄, LiPF₆, LiNO₃, LiN(CF₃SO₂)₂, LiN(C₂F₅SO₂)₂, LiAsF₆, LiCF₃SO₃, LiC(SO₂CF₃)₃, LiAlCl₄, and LiSiF₆. From the viewpoint of oxidation stability, LiPF₆ and LiBF₄ are preferred. These lithium salts may be used alone or in combination as a mixture. The concentration for dissolving the lithium salt may be any as long as the lithium salt can be dissolved in the nonaqueous solvent. The lithium ion concentration is preferably in the range of 0.4 mol/kg to 2.0 mol/kg relative to the nonaqueous solvent.

When a gel electrolyte is used, the electrolyte described above is gelled with a matrix polymer. The matrix polymer may be any polymer that is compatible with the nonaqueous electrolytic solution prepared by dissolving the electrolyte salt in the nonaqueous solvent and that can be gelled. Examples of the matrix polymer include polymers that contain polyvinylidene fluoride, polyethylene oxide, polypropylene oxide, polyacrylonitrile, and polymethacrylonitrile in the repeating units. These polymers can be used alone or in combination.

In particular, polyvinylidene fluoride and a copolymer in which 7.5% or less of hexafluoropropylene is introduced into polyvinylidene fluoride are preferred as the matrix polymer. Such a polymer usually has a number-average molecular weight in the range of 5.0×10⁵ to 7.0×10⁵ (500 thousand to 700 thousand) or a weight-number molecular weight in the range of 2.1×10⁵ to 3.1×10⁵ (210 thousand to 310 thousand), and an intrinsic viscosity in the range of 1.7 to 2.1 dl/g.

Separator

The separator is made of a porous film composed of an inorganic material, such as a ceramic nonwoven cloth or a porous film composed of a polyolefin material such as polypropylene (PP) or polyethylene (PE) and may have a multilayer structure including two or more types of these porous films. Of these, porous films composed of polyethylene or polypropylene are most effective.

In general, a separator having a thickness of 5 to 50 μm is suitable for use. The thickness is more preferably 7 to 30 μm. If the separator is excessively thick, the filling ratio of the active material decreases, thereby decreasing the battery capacity and ion conductivity and degrading the current characteristics. If the separator is excessively thin, the mechanical strength of the film decreases.

Production of Battery

The gel electrolyte solution prepared as above is evenly applied onto the positive electrode 11 and the negative electrode 12 to impregnate the positive electrode active material layer and the negative electrode active material layer, and either stored at normal temperature or subjected to a drying step to form gel electrolyte layers 14.

Next, the positive electrode 11 provided with the gel electrolyte layers 14, the separator 13a, the negative electrode 12 provided with the gel electrolyte layers 14, and the separator 13b are sequentially stacked in that order and wound to form a battery element 10. Then the battery element 10 is placed in the recess (space) 17a in the laminate film 17 to obtain a gel nonaqueous electrolyte secondary battery.

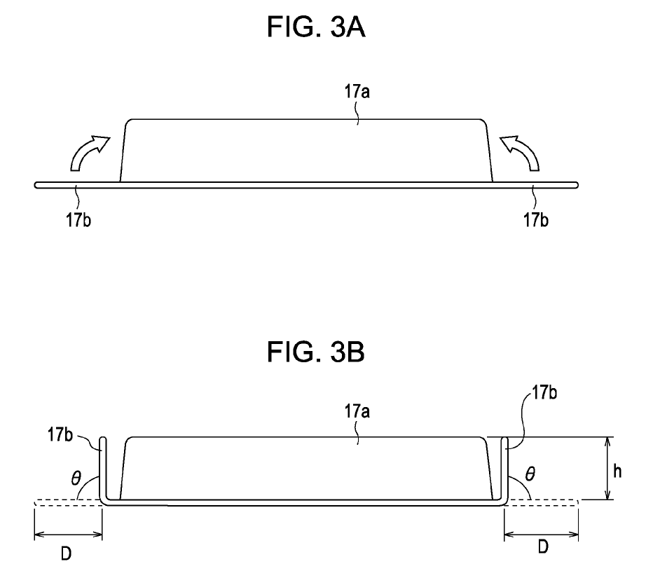

In this embodiment, as shown in FIGS. 1, 3A, and 3B, the battery element 10 is packaged with the laminate film 17 described above and the periphery of the battery element 10 is melt-bonded and sealed to obtain a battery 20. After the battery element 10 is housed and sealed with the laminate film 17, two side portions (also referred to as “side sealing portions” hereinafter) 17b of the recess 17a housing the battery element 10 are bent toward the recess 17a, as shown in FIGS. 3A and 3B.

The bending angle θ is preferably in the range of 80° to 100°. At a bending angle less than 80°, the side sealing portions 17b at the two sides of the recess 17a are excessively open and this increases the width of the battery 20 and makes it difficult to reduce the size of and improve the battery capacity of the battery 20. The upper limit value, 100°, is the value defined by the shape of the recess 17a. When the battery element 10 housed has a flat shape, the upper limit value of the bending angle is about 100°. The width taken for thermal melt bonding at the side sealing portions 17b is preferably 0.5 to 2.5 mm and more preferably 1.5 to 2.5 mm.

The bending width D of the side sealing portions 17b is preferably equal to or more than the height h of the recess 17a or the thickness of the battery element 10 to reduce the size of and improve the battery capacity of the battery 20. The number of times of bending is preferably 1 in order to reduce the size of and improve the battery capacity of the battery 20.

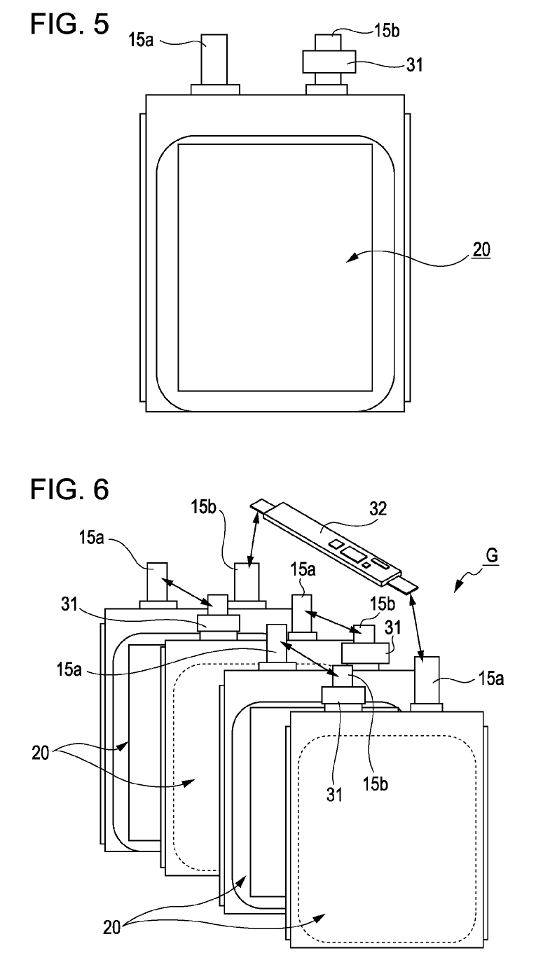

Next, an embodiment of a method for producing a battery pack is described. The battery 20, i.e., the battery 20 including the battery element 10 packaged with the laminate film 17, the battery element 10 including the positive electrode 11, the negative electrode 12, and the separators 13a and 13b packaged with the laminate film 17, has the positive electrode terminal 15a and the negative electrode terminal 15b extended to the outside as shown in FIG. 5. According to the battery pack P shown in FIG. 4, a plurality of the aforementioned batteries 20 (four in the example shown in the drawing) are included and electrically connected to each other through the connecting members 31 to form the battery group G while the batteries 20 are held together with the holder 33A.

In the battery pack P shown in FIG. 4, four batteries 20 are arranged so that their fronts and backs alternate and the positive electrode terminal 15a and the negative electrode terminal 15b of adjacent batteries 20 are connected to each other with the connecting member 31. In other words, four batteries 20 are connected in series. Then as shown in FIG. 6, the negative electrode terminal 15b of the battery 20 at one end and the positive electrode terminal 15a of the battery 20 at the other end are connected to the protection circuit substrate 32. The protection circuit substrate 32 controls the voltage and current of the battery group G that includes the batteries 20.

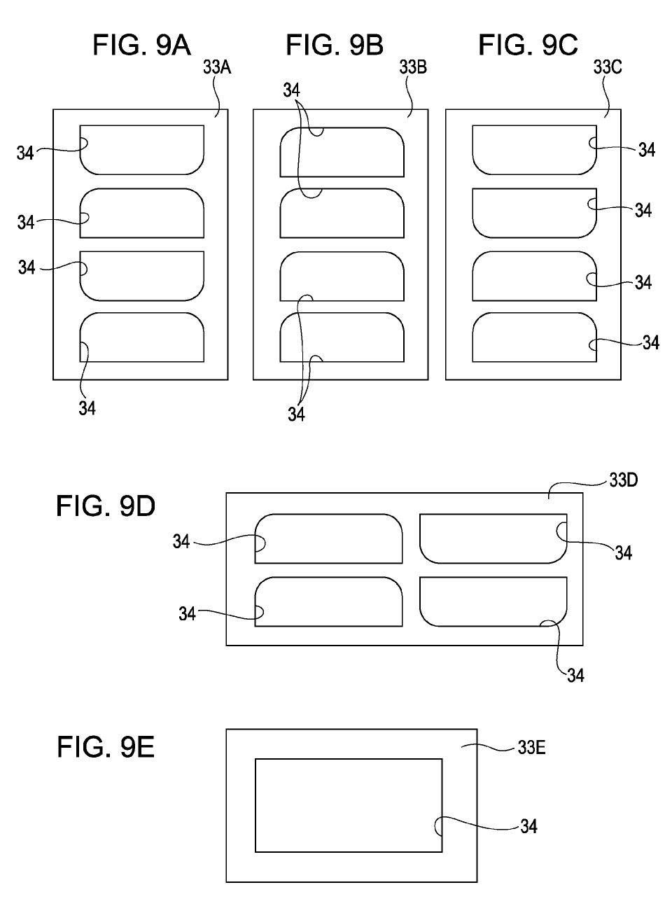

Moreover, as shown in FIG. 9A, a holder 33A having openings 34 corresponding to the arrangement of the battery 20 is used in the battery pack P. The openings 34 shown in the drawing have shapes corresponding to the cross-sectional faces of the batteries 20 taken in the thickness direction. The holder 33A holds the batteries 20 together as the batteries 20 are fitted into the openings 34.

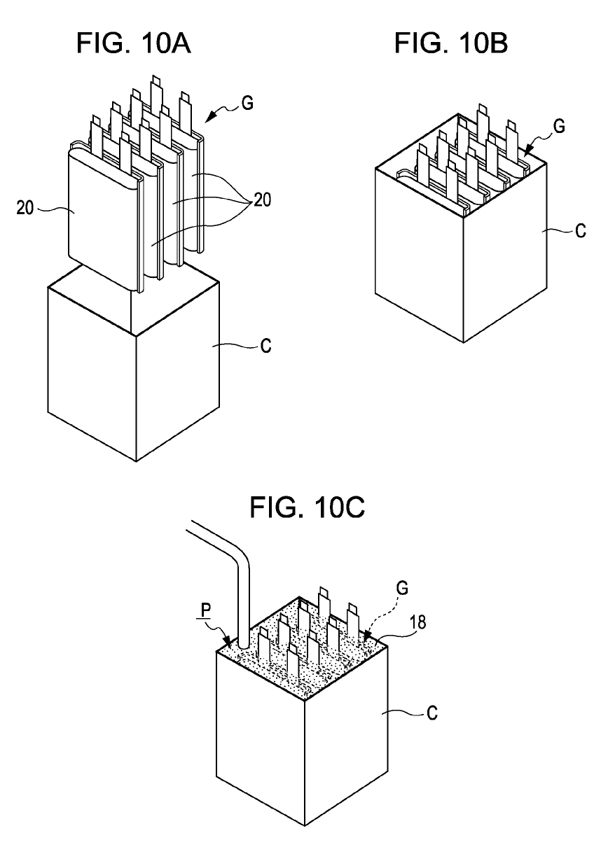

As shown in FIGS. 10A and 10B, the battery group G and the protection circuit substrate 32 are placed in a cubic casing (molding die) C having an open upper end while having the electrode terminals 15a and 15B and the protection circuit substrate 32 facing upward. Note that although the connecting members 31, the protection circuit substrate 32, and the holder 33A are omitted from the drawings in FIGS. 10A and 10B, they are also housed in the casing C together with the battery group G. During this process, the holder 33A functions as a positioning unit inside the casing C and contributes to further improvements of workability and quality.

Subsequently, as shown in FIG. 10C, the space in the casing C housing the battery group G and the protection circuit substrate 32 is filled with a molten resin containing a shape-retaining polymer, a filler, etc., supplied through a nozzle and the resin is cured at 100° C. or less to prepare the outer packaging member 18. As a result, a battery pack P in which the battery group G, the protection circuit substrate 32, and other associated components are integrally covered with the outer packaging member 18 is obtained. When the casing C is used as the molding die as in this embodiment, the casing C can be detached or can be formed as a part of the battery pack P.

When a highly viscous resin is used as the resin for forming the outer packaging member 18, the resin is usually filled by applying pressure to prevent generation of gaps inside the molding space in the casing C. During this process, the holder 33A exhibits a positioning function of keeping the battery group G and the protection circuit substrate 32 in place against the resin being filled under pressure. Alternatively, the resin injection may be divided into two or more operations.

The battery pack P of this embodiment includes a plurality of batteries 20 having a volume energy density higher than that of the battery using a metal can. Even when rectangular batteries 20 having high volume efficiency are used, the dimensional accuracy and the mechanical strength improve and size and weight reduction and further improvements of safety and reliability can be achieved.

Since the battery pack P has good dimensional accuracy and mechanical strength and can realize size and weight reduction, the battery pack P can be used as the batteries for mobile appliances such as cellular phones, laptop computers, and digital cameras, secondary batteries for electric and hybrid cars that involve high output, and batteries for power tools.

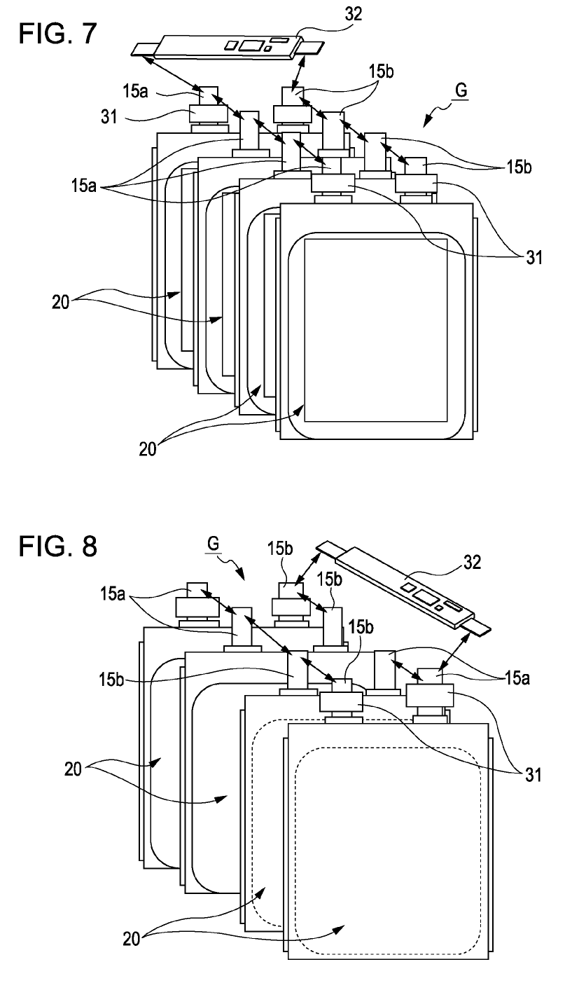

FIG. 7 is a diagram showing another example of a battery group. The battery group G illustrated in the drawing has four batteries 20 arranged with the same orientation. The positive electrode terminals 15a are connected to each other through a connecting member 31 and the negative electrode terminals 15b are connected to each other through a different connecting member 31. In other words, four of the batteries 20 are connected in parallel. The positive electrode terminal 15a and the negative electrode terminal 15b of the battery 20 at one end are connected to the protection circuit substrate 32. In this case, as shown in FIG. 9B, a holder 33B having openings 34 corresponding to the arrangement of the batteries 20 is used.

FIG. 8 is a diagram showing yet another example of a battery group. In the battery group G shown in the drawing, the positive electrode terminals 15a of two of the batteries 20 are connected to each other with a connecting member 31 and the negative electrode terminals 15b of two of the batteries 20 are connected to each other with another connecting member 31. Two sets of such batteries are provided. The positive electrode terminal 15a of one set of the batteries 20 is connected to the negative electrode terminal 15b of the other set of the batteries 20 through another connecting member 31. In other words, two of the batteries 20 are connected in parallel to form a set, and two such sets are connected to each other in series. Then the negative electrode terminal 15b of the battery 20 of one set and the positive electrode terminal 15a of the battery 20 of the other set are connected to the protection circuit substrate 32. In this case, as shown in FIG. 9C, a holder 33C having openings 34 corresponding to the arrangement of the batteries 20 is used.

The holder may be a holder 33D having the openings 34 arranged in columns and rows as shown in FIG. 9D, or a holder 33E having an opening 34 having a shape corresponding to the front shape of the main unit of the battery 20 as shown in FIG. 9E.

The number of batteries 20 included in the battery group G included in a battery pack may be any instead 4, and series connections and parallel connections may be freely combined as desired. Accordingly, the holder for the battery group G may also take various forms other than those described above illustrated in the drawings.

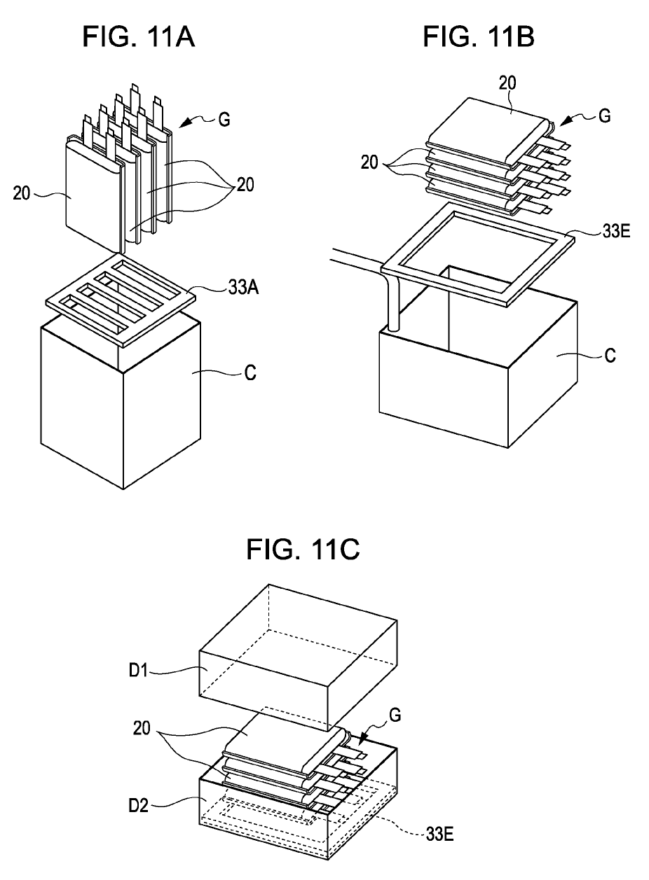

Each of the holders 33A to 33E is housed in a molding die together with the battery group G etc., as shown in FIGS. 11A to 11C, holds the batteries 20 together, fixes the positions of the batteries 20 in the die, and is integrally covered with a resin (outer packaging member 18) filled in the molding die together with the battery group G and the protection circuit substrate 32.

The molding die may be a casing C that houses a vertically disposed battery group G along with the holder 33A as shown in FIGS. 10A, 10B, 10C, and 11A, or a casing C that houses a horizontally disposed battery group G along with the holder 33E as shown in FIG. 11B. The molding die may be constituted by upper and lower assemble dies D1 and D2 as shown in FIG. 11C or may take any form without any limitation.

### EXAMPLES

The present application will now be described in further detail using Examples and Comparative Examples but the present application is not limited to these examples.

### Examples 1 to 18 and Comparative Examples 1 to 3

Characteristics of the outer packaging member (resin), i.e., the types of the shape-retaining polymer and the inorganic filler, the deflection temperature under load, the glass transition point, the elongation, and the curing technique (curing temperature), were varied and battery packs each including a battery group integrally packaged with a respective outer packaging member were prepared by using the production method described above. Then the performance of the battery packs of the respective examples was evaluated.

Rated energy density (Wh/l) was determined at a temperature of 23° C. by repeating, for 15 hours at an upper limit of 4.2 V, 1 C constant-current, constant-voltage charging and 1 C constant-current discharging down to a final voltage of 2.5 V, where the rated energy density was determined on the basis of the discharge capacity of the first cycle.

Rated energy density (Wh/l)=(Average discharge voltage (V)×rated capacity (Ah))/battery volume

Note that 1 C represents a current value at which the theoretical capacity of the battery can be released in 1 hour.

Each battery pack was subjected to 0.2 C-50 V charging and 0.2 C-30 V discharging and then 1 C charging/discharging was conducted ten times so that the battery pack was fully charged at 50 V (average voltage: 4.17 V). Then the battery was subjected to a 24 hour vibration test according to JIS D1601. In the vibration test, each battery pack was placed in a 200×200×200 mm casing and fixed with an adhesive tape, 10 g of 50 μm silica particles simulating sand were placed in the casing, and vibrations having a frequency of 33 Hz and an acceleration of 10 G were applied in the horizontal and vertical directions. In the vibration test, the voltage of each layer of each battery was regularly monitored through a voltage monitor tab. A battery that included a layer the voltage of which dropped by 0.05 V or more from the average voltage of the layer was assumed to be an abnormal battery. The number of abnormal batteries was recorded and values observed from such abnormal batteries were excluded from determination of averages.

A 720 hour vibration test was also performed. The rate of change in thickness, visual appearance, and capacity retention ratio of the most deteriorated battery after 10,000 cycles, and the maximum temperature observed in an overcharge test were also investigated. The results are shown in Tables 1 and 2.

TABLE 1

| | | | Deflection | Glass | | |
|---|---|---|---|---|---|---|
| | Shape- | | temperature | transition | | |
| | retaining | Inorganic | under load | point (Tg) | Elongation | |
| | polymer | filler | (° C.) | (° C.) | (%) | Curing |
| Ex. 1 | Acryl | None | 58 | 50 | 41 | 100° C. |
| Ex. 2 | Epoxy | None | 152 | 152 | 4 | 100° C. |
| Ex. 3 | Epoxy | None | 58 | 55 | 41 | 100° C. |
| Ex. 4 | Urethane | None | 156 | 150 | 5 | 100° C. |
| Ex. 5 | Urethane | None | 58 | 55 | 40 | 85° C. |
| Ex. 6 | Urethane | None | 60 | 55 | 40 | 85° C. |
| Ex. 7 | Acryl | SiO₂ | 68 | 64 | 24 | 85° C. |
| | | particles | | | | |
| Ex. 8 | Epoxy | Al₂O₃ | 132 | 127 | 13 | 85° C. |
| | | particles | | | | |
| Ex. 9 | Urethane | SiO₂flakes | 150 | 145 | 13 | 85° C. |
| Ex. 10 | Urethane | Al₂O₃ flakes | 68 | 66 | 24 | 85° C. |
| Ex. 11 | Urethane | SiO₂ | 70 | 64 | 24 | 85° C. |
| | | particles | | | | |
| Ex. 12 | Urethane | Al₂O₃ | 71 | 66 | 24 | 85° C. |
| | | particles | | | | |
| Ex. 13 | Urethane | AlN | 130 | 125 | 13 | 85° C. |
| | | particles | | | | |
| Ex. 14 | Urethane | Si₃N₄ | 120 | 114 | 15 | 85° C. |
| | | particles | | | | |
| Ex. 15 | Urethane | AlN flakes | 70 | 65 | 22 | 60° C. |
| Ex. 16 | Urethane | Si₃N₄ | 75 | 70 | 18 | 45° C. |
| | | flakes | | | | |
| Ex. 17 | Urethane | AlN | 105 | 120 | 17 | 45° C. |
| | | fibers | | | | |
| Ex. 18 | Urethane | Si₃N₄ | 105 | 110 | 17 | 45° C. |
| | | fibers | | | | |
| C.E. 1 | ABS | None | 130 | 120 | 15 | 120° C., molten |
| | | | | | | resin extrusion |
| | | | | | | molding |
| C.E. 2 | Polyurethane | None | 120 | 110 | 15 | 110° C., molten |
| | | | | | | resin extrusion |
| | | | | | | molding |
| C.E. 3 | None/ | None | None | None | None | None |
| | polycarbonate | | | | | |
| | resin mold | | | | | |
| | pack | | | | | |

| | | No. of | | | | |
|---|---|---|---|---|---|---|
| | No. of | groups of | | | | |
| | batteries | batteries | Total | | | Capacity |
| | connected | connected | No. of | Packaging | Dimension | of unit |
| | in series | in parallel | batteries | material | of unit cell | cell (Ah) |
| Ex. 1 | 3 | 2 | 6 | Al laminate | 6E+0.5 | 3 |
| Ex. 2 | 4 | 1 | 4 | Al laminate | 6E+0.5 | 3 |
| Ex. 3 | 4 | 1 | 4 | Al laminate | 6E+0.5 | 3 |
| Ex. 4 | 4 | 1 | 4 | Al laminate | 6E+0.5 | 3 |
| Ex. 5 | 4 | 1 | 4 | Al laminate | 6E+0.5 | 3 |
| Ex. 6 | 4 | 1 | 4 | Al laminate | 6E+0.5 | 3 |
| Ex. 7 | 4 | 1 | 4 | Al laminate | 6E+0.5 | 3 |
| Ex. 8 | 4 | 1 | 4 | Al laminate | 6E+0.5 | 3 |
| Ex. 9 | 4 | 1 | 4 | Al laminate | 6E+0.5 | 3 |
| Ex. 10 | 4 | 1 | 4 | Al laminate | 6E+0.5 | 3 |
| Ex. 11 | 4 | 1 | 4 | Al laminate | 6E+0.5 | 3 |
| Ex. 12 | 4 | 1 | 4 | Al laminate | 6E+0.5 | 3 |
| Ex. 13 | 4 | 1 | 4 | Al laminate | 6E+0.5 | 3 |
| Ex. 14 | 4 | 1 | 4 | Al laminate | 6E+0.5 | 3 |
| Ex. 15 | 4 | 1 | 4 | Al laminate | 6E+0.5 | 3 |
| Ex. 16 | 4 | 1 | 4 | Two | 6E+0.5 | 3.2 |
| | | | | layers: PE | | |
| | | | | film + PET | | |
| | | | | film | | |
| Ex. 17 | 4 | 1 | 4 | Two | 6E+0.5 | 3.2 |
| | | | | layers: PP | | |
| | | | | film + PET | | |
| | | | | film | | |
| Ex. 18 | 4 | 1 | 4 | One layer: | 6E+0.5 | 3.3 |
| | | | | PE film | | |
| C.E. 1 | 4 | 1 | 4 | Al laminate | 6E+0.5 | 2.7 |
| C.E. 2 | 4 | 1 | 4 | Al laminate | 6E+0.5 | 2.8 |
| C.E. 3 | 4 | 1 | 4 | Al can | 6E+0.5 | 3 |

Ex.: Example
C.E.: Comparative Example

TABLE 2

| | | | | | | | Failure |
|---|---|---|---|---|---|---|---|
| | | | | | | Failure | rate after |
| | Average | Pack dimensions | | | Rated E | rate after | 720 H vibration |
| | discharge | Thick- | | | density | 24 H vibration | test (reference |
| | potential | ness | Length | Width | (Wh/l) | test | test) |
| Ex. 1 | 3.7 | 21 | 92 | 100 | 345 | Pass: all 20 | Fail: all 20 |
| Ex. 2 | 3.7 | 27 | 48 | 100 | 343 | Pass: all 20 | Fail: all 20 |
| Ex. 3 | 3.7 | 27 | 48 | 100 | 343 | Pass: all 20 | Fail: 17 |
| Ex. 4 | 3.7 | 26 | 47 | 99 | 367 | Pass: all 20 | Fail: 13 |
| Ex. 5 | 3.7 | 26 | 47 | 99 | 367 | Pass: all 20 | Fail: 11 |
| Ex. 6 | 3.7 | 26 | 47 | 99 | 367 | Pass: all 20 | Fail: 8 |
| Ex. 7 | 3.7 | 26 | 47 | 99 | 367 | Pass: all 20 | Fail: 8 |
| Ex. 8 | 3.7 | 26 | 47 | 99 | 367 | Pass: all 20 | Fail: 8 |
| Ex. 9 | 3.7 | 26 | 47 | 99 | 367 | Pass: all 20 | Fail: 8 |
| Ex. 10 | 3.7 | 26 | 46 | 98 | 386 | Pass: all 20 | Fail: 7 |
| Ex. 11 | 3.7 | 26 | 46 | 98 | 386 | Pass: all 20 | Fail: 7 |
| Ex. 12 | 3.7 | 26 | 46 | 98 | 386 | Pass: all 20 | Fail: 2 |
| Ex. 13 | 3.7 | 26 | 46 | 98 | 386 | Pass: all 20 | Fail: 2 |
| Ex. 14 | 3.7 | 25 | 46 | 97.5 | 400 | Pass: all 20 | Pass: all 20 |
| Ex. 15 | 3.7 | 25 | 46 | 97.5 | 400 | Pass: all 20 | Pass: all 20 |
| Ex. 16 | 3.7 | 25 | 45 | 97 | 434 | Pass: all 20 | Pass: all 20 |
| Ex. 17 | 3.7 | 25 | 45 | 97 | 434 | Pass: all 20 | Pass: all 20 |
| Ex. 18 | 3.7 | 25 | 45 | 97 | 448 | Pass: all 20 | Pass: all 20 |
| C.E. 1 | 3.6 | 27 | 48 | 100 | 300 | Fail: all 20 | Fail: all 20 |
| C.E. 2 | 3.6 | 27 | 48 | 100 | 311 | Fail: 11/20 | Fail: all 20 |
| C.E. 3 | 3.7 | 27 | 48 | 100 | 343 | Fail: 12/20 | Fail: all 20 |

| | Rate of | Visual | Capacity | Maximum |
|---|---|---|---|---|
| | change in | appearance | retention rate of | temperature |
| | thickness | test after | most deteriorated | at overcharge |
| | after 10,000 | 10,000 | battery after | test at 50° C., |
| | cycles (%) | cycles | 10,000 cycles (%) | 3 C, 100 V |
| Ex. 1 | 14 | Deformation | 62 | 151 |
| Ex. 2 | 13 | Crack | 63 | 149 |
| Ex. 3 | 12 | Deformation | 66 | 122 |
| Ex. 4 | 12 | Deformation | 69 | 121 |
| Ex. 5 | 10 | Deformation | 72 | 117 |
| Ex. 6 | 7 | Deformation | 75 | 105 |
| Ex. 7 | 7 | Deformation | 77 | 104 |
| Ex. 8 | 7 | Deformation | 78 | 103 |
| Ex. 9 | 7 | Deformation | 79 | 102 |
| Ex. 10 | 7 | Good | 81 | 91 |
| Ex. 11 | 7 | Good | 81 | 90 |
| Ex. 12 | 7 | Good | 82 | 82 |
| Ex. 13 | 7 | Good | 82 | 71 |
| Ex. 14 | 3 | Good | 83 | 70 |
| Ex. 15 | 3 | Good | 83 | 70 |
| Ex. 16 | 3 | Good | 83 | 70 |
| Ex. 17 | 3 | Good | 83 | 70 |
| Ex. 18 | 3 | Good | 83 | 70 |
| C.E. 1 | 28 | Swelling | <10 | >400 |
| C.E. 2 | 24 | Swelling | <10 | >400 |
| C.E. 3 | 31 | Swelling | <10 | >400 |

Ex.: Example, C.E.: Comparative Example

As apparent from Tables 1 and 2, the battery packs of Examples 1 to 18 achieved better results than Comparative Examples 1 to 3 in terms of 24H vibration test, rate of change in thickness, visual appearance, and capacity retention ratio of the most deteriorated battery after 10,000 cycles as well as the maximum temperature observed in the overcharge test. This confirms that the battery packs of Examples 1 to 18 all have sufficient mechanical strength as well as high dimensional accuracy.

In particular, the battery packs of Examples 10 to 18 maintained excellent appearance and battery packs of Examples 14 to 18 achieved zero failure after 720H vibration test.

### Examples 19 to 39 and Comparative Examples 4 and 5

The resin of the outer packaging member, the endothermic agent contained in the resin, the type (composition) of the endothermic agent, the onset temperature of endothermic reactions, the amount added, and the curing technique (curing temperature) were varied and battery packs each including a battery group integrally covered with the respective outer packaging member were prepared according to the production method above. Then the performance of the battery packs of the respective examples was evaluated.

The rated energy density (Wh/l) was as described above. The change in dimension after 1 month of storage at 60° C., the time taken for the inside temperature to exceed 100° C. in an overcharge test at 50° C., C3, 20 V, and the maximum temperature in a nail penetration test at 60° C. were investigated. The results are shown in Tables 3 and 4.

TABLE 3

| | | | | Endothermic | | |
|---|---|---|---|---|---|---|
| | | | Type of | reaction | | |
| | | | endothermic | on-set | Content | |
| | Resin | Endothermic agent | agent | temperature | (wt %) | Curing |
| Ex. 19 | Acryl | Nickel hydroxide | Metal | 247 | 1 | 100° C. |
| | | | hydroxide | | | |
| Ex. 20 | Epoxy | Cobalt hydroxide | Metal | 231 | 60 | 100° C. |
| | | | hydroxide | | | |
| Ex. 21 | Acryl | Zinc hydroxide | Metal | 205 | 60 | 100° C. |
| | | | hydroxide | | | |
| Ex. 22 | Urethane | Aluminum hydroxide | Metal | 175 | 60 | 100° C. |
| | | | hydroxide | | | |
| Ex. 23 | Acryl | Tetrahydrofuran | Clathrate | 152 | 1 | 100° C. |
| | | | hydrate | | | |
| Ex. 24 | Epoxy | Cyclodextrin | Clathrate | 88 | 1 | 70° C. |
| | | | hydrate | | | |
| Ex. 25 | Urethane | Aluminum silicate n- | Hydrate | 148 | 2 | 80° C. |
| | | hydrate | | | | |
| Ex. 26 | Urethane | Copper sulfate 5- | Hydrate | 90 | 40 | 60° C. |
| | | hydrate | | | | |
| Ex. 27 | Urethane | Sodium sulfate 10- | Hydrate | 91 | 35 | 60° C. |
| | | hydrate | | | | |
| Ex. 28 | Urethane | Zirconium dioxide | Hydrate | 145 | 4 | 80° C. |
| | | hydrate | | | | |
| Ex. 29 | Urethane | Aluminum chloride | Hydrate | 141 | 4 | 80° C. |
| | | 6-hydrate | | | | |
| Ex. 30 | Urethane | Cobalt chloride 6- | Hydrate | 139 | 30 | 80° C. |
| | | hydrate | | | | |
| Ex. 31 | Urethane | calcium sulfate | Hydrate | 137 | 30 | 85° C. |
| | | hydrate | | | | |
| Ex. 32 | Urethane | Zinc sulfate 7- | Hydrate | 135 | 30 | 85° C. |
| | | hydrate | | | | |
| Ex. 33 | Urethane | Nickel nitrate 6- | Hydrate | 134 | 10 | 85° C. |
| | | hydrate | | | | |
| Ex. 34 | Urethane | Magnesium sulfate | Hydrate | 133 | 10 | 85° C. |
| | | hydrate | | | | |
| Ex. 35 | Urethane | Gypsum | Hydrate | 132 | 10 | 85° C. |
| Ex. 36 | Urethane | Calcium sulfate | Hydrate | 128 | 15 | 60° C. |
| | | hydrate | | | | |
| Ex. 37 | Urethane | Basic zinc carbonate | Carbonate | 120 | 15 | 45° C. |
| Ex. 38 | Urethane | Copper hydroxide | Metal | 100 | 15 | 45° C. |
| | | | hydroxide | | | |
| Ex. 39 | Urethane | Calcium sulfite | Hydrate | 100 | 15 | 45° C. |
| C.E. 4 | Al can | Nickel hydroxide | Metal | 247 | 20 | 120° C., molten |
| | | | hydroxide | | | resin extrusion |
| | | | | | | molding |
| C.E. 5 | None/ | Nickel hydroxide | Metal | 247 | 20 | 280° C. |
| | polycarbonate | | hydroxide | | | |
| | resin | | | | | |
| | mold pack | | | | | |

Ex: Example, C.E.: Comparative Example

TABLE 4

| | | | Change (t in | Time taken for inside | |
|---|---|---|---|---|---|
| | | | dimension after 1 | temperature to | Maximum temperature in |
| | | Rated E | month of storage | exceed 100° C. in a | 60° C. needle penetration |
| | Packaging | density | at 60° C., 4.25 V | 50° C., 3 C, 20 V | test (excluding portions |
| | material | (Wh/l) | (%) | overcharge test (sec) | penetrated with needle) |
| Ex. 19 | Al laminate | 505 | 9 | 314 | 132 |
| Ex. 20 | Al laminate | 505 | 9 | 312 | 131 |
| Ex. 21 | Al laminate | 505 | 9 | 311 | 130 |
| Ex. 22 | Al laminate | 505 | 8 | 310 | 129 |
| Ex. 23 | Al laminate | 505 | 8 | 308 | 128 |
| Ex. 24 | Al laminate | 510 | 7 | 294 | 121 |
| Ex. 25 | Al laminate | 520 | 5 | 281 | 119 |
| Ex. 26 | Al laminate | 520 | 5 | 279 | 119 |
| Ex. 27 | Al laminate | 520 | 5 | 278 | 119 |
| Ex. 28 | Al laminate | 520 | 5 | 277 | 119 |
| Ex. 29 | Al laminate | 520 | 5 | 276 | 119 |
| Ex. 30 | Al laminate | 520 | 4 | 248 | 114 |
| Ex. 31 | Al laminate | 520 | 4 | 246 | 114 |
| Ex. 32 | Al laminate | 520 | 4 | 245 | 113 |
| Ex. 33 | Al laminate | 520 | 4 | 244 | 113 |
| Ex. 34 | Al laminate | 520 | 4 | 243 | 113 |
| Ex. 35 | Al laminate | 520 | 4 | 241 | 113 |
| Ex. 36 | Al laminate | 530 | 3 | 152 | 108 |
| Ex. 37 | Two layers: | 548 | 2 | 53 | 107 |
| | PE film + PET | | | | |
| | film | | | | |
| Ex. 38 | Two layers: | 555 | 1 | 51 | 106 |
| | PP film + PET | | | | |
| | film | | | | |
| Ex. 39 | One layer: PE | 560 | 1 | 47 | 105 |
| | film | | | | |
| C.E. 4 | Al laminate | Battery | No cycle | Thermal runaway | >400 |
| | | capacity <10% | | | |
| C.E. 5 | Al laminate | 480 | 12 | Thermal runaway | >400 |

### Ex: Example, C.E.: Comparative Example

As apparent from Tables 3 and 4, the battery packs of Examples 19 to 39 achieved better results than Comparative Examples 4 and 5 in terms of changes in dimension after 1 month, time taken for the inside temperature to exceed 100° C. in the overcharge test, and maximum temperature in the needle penetration test. In particular, the maximum temperature in the nail penetration test was significantly lower than that of the Comparative Examples 4 and 5, which confirmed that the temperature suppressing effect of the endothermic agent is significant and the safety is high.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A battery pack comprising:
a plurality of batteries, each including a battery element formed by winding or stacking a positive electrode and a negative electrode with a separator therebetween, and a packaging material packaging the battery element;
a connecting member that electrically connects the batteries to form a battery group;
holding means for holding the batteries together;
a protection circuit substrate connected to the battery group; and
an outer packaging member that integrally covers the battery group and the protection circuit substrate, the outer packaging member being formed by filling a space in a molding die housing the battery group and the protection circuit substrate with a resin and curing the resin at a temperature of 100° C. or less.

2. The battery pack according to claim 1, wherein the resin of the outer packaging member contains one resin selected from a urethane resin, an acryl resin, and an epoxy resin.

3. The battery pack according to claim 1, wherein the resin of the outer packaging member is a curable resin selected from a urethane resin, an acryl resin, and an epoxy resin and contains an endothermic agent composed of a compound that undergoes an endothermic reaction.

4. The battery pack according to claim 2, wherein the resin of the outer packaging member has an elongation of 5% or more and 40% or less according to Japanese Industrial Standard K-7113.

5. The battery pack according to claim 2, wherein the resin of the outer packaging member has a deflection temperature of 60° C. or more under a 0.45 MPa load according to Japanese Industrial Standard K-7191 or has a glass transition temperature (Tg) of 55° C. or more.

6. The battery pack according to claim 2, wherein the resin of the outer packaging member contains one of an oxide containing Al or Si and a nitride containing Al or Si.

7. The battery pack according to claim 1, wherein the packaging material packaging the battery element is a film having at least one layer and contains one of polyolefin and polyvinylidene films.

8. The battery pack according to claim 3, wherein the compound undergoes the endothermic reaction at a temperature in the range of 90° C. to 150° C.

9. The battery pack according to claim 8, wherein the compound that undergoes the endothermic reaction contains at least one selected from a hydroxide, a hydrate, a clathrate compound, a hydrate salt, and a carbonate compound.

10. The battery pack according to claim 9, wherein the hydroxide is a hydroxide of a metal selected from copper, zinc, aluminum, cobalt, and nickel.

11. The battery pack according to claim 9, wherein the hydrate is a hydrate of a metal selected from copper, zinc, aluminum, cobalt, calcium, zirconium, nickel, and magnesium.

12. The battery pack according to claim 1, wherein the packaging material for the battery element is an aluminum laminate film.

13. A battery pack comprising:
a plurality of batteries, each including a battery element formed by winding or stacking a positive electrode and a negative electrode with a separator therebetween, and a packaging material packaging the battery element;
a connecting member that electrically connects the batteries to form a battery group;
a holding unit that holds the batteries together;
a protection circuit substrate connected to the battery group; and
an outer packaging member that integrally covers the battery group and the protection circuit substrate, the outer packaging member being formed by filling a space in a molding die housing the battery group and the protection circuit substrate with a resin and curing the resin at a temperature of 100° C. or less.
